(19) United States
(12) Patent Application Publication
(10) Pub. No.: US 2019/0237950 A1
(43) Pub. Date: Aug. 1, 2019

(54) Corner Guide for Wire Installation

(71) Applicant: Michael Lee Schroder, Littleton, CO (US)

(72) Inventor: Michael Lee Schroder, Littleton, CO (US)

(21) Appl. No.: 16/184,082

(22) Filed: Nov. 8, 2018

Related U.S. Application Data
(60) Provisional application No. 62/623,827, filed on Jan. 30, 2018.

(51) Int. Cl. H02G 3/04; F16L 3/12; F16L 3/24; H02G 3/32

(52) U.S. Cl. CPC H02G 3/0481; F16L 3/12; H02G 3/0406; H02G 3/32; F16L 3/24

(57) ABSTRACT

A corner guide for wire installation may include a rod having a curvature, a first clip at one end of the rod, and a second clip at an opposite end of the rod. The first and second clips are connected to a building structure at or near a corner to secure the rod in position so that the rod provides a smooth surface for one or more of wires, cables, or bundles of wires to be pulled around the corner. The rod can be bent to a desired angle at the time of installation, or pre-formed such that it fits snuggly on trusses, girders, rafters, and other elements of building structures to define the corner.

### CROSS REFERENCE TO RELATED APPLICATIONS

This application claims the priority benefit of U.S. Provisional Patent Application No. 62/623,827 filed Jan. 30, 2018 for “Corner Guide For Wire Installation” of Michael Lee Schroder, hereby incorporated by reference in its entirety as though fully set forth herein.

### BACKGROUND

When installing wires in walls or ceilings, the wires often have to be pulled around corners. In the past, wire installation technicians have had to use plastic wire ties to strap the cables in place, and then pull large lengths of extra wire past a corner or turn. This can cause the insulating sheathing of the wire to becoming scraped, stretched, snagged, or frayed, potentially exposing the conductive elements of the wire itself. This can cause a short circuit or even be a fire hazard if not corrected. Correction of course, requires the wire installation technician to redo the work, which is time-consuming and expensive, causing delays and frustration.

### BRIEF DESCRIPTION OF THE DRAWINGS

FIG. 1 is a perspective view of an example corner guide for wire installation as it may be installed on the support structure of a ceiling.

FIG. 2 is a perspective view of an example corner guide for wire installation.

FIG. 3 is a perspective view of another example corner guide for wire installation.

### DETAILED DESCRIPTION

A corner guide for wire installation is disclosed. In an example, the corner guide for wire installation provides a labor saving device that can save time and reduce cost of installation of one or more wires or cables, as well as improving safety and durability. The smooth surface of the corner guide removes sharp corners and rough protrusions that might otherwise fray, abrade, snag, and/or stretch a wire, cable, or bundle of wires or cables during installation. As such, the corner guide enables low voltage and high voltage wires to gain added protection during wire installation in commercial or residential or other buildings, and prevents damage to the exterior insulating jacket of the wires during the installation.

Before continuing, it is noted that as used herein, the terms “includes” and “including” mean, but is not limited to, “includes” or “including” and “includes at least” or “including at least.” The term “based on” means “based on” and “based at least in part on.” The term “or” shall be interpreted to mean “and/or” or “logical or” rather than “exclusive or”. Plurals shall be interpreted as including the possibility of singular items.

It is also noted that the examples shown and described herein are provided for purposes of illustration, and are not intended to be limiting. Other devices or device configurations may be utilized to carry out the operations described herein. The components and operations shown and described herein are provided to illustrate example implementations. It is noted that the components and operations are not limited to the ordering shown. Still other components and operations may also be implemented.

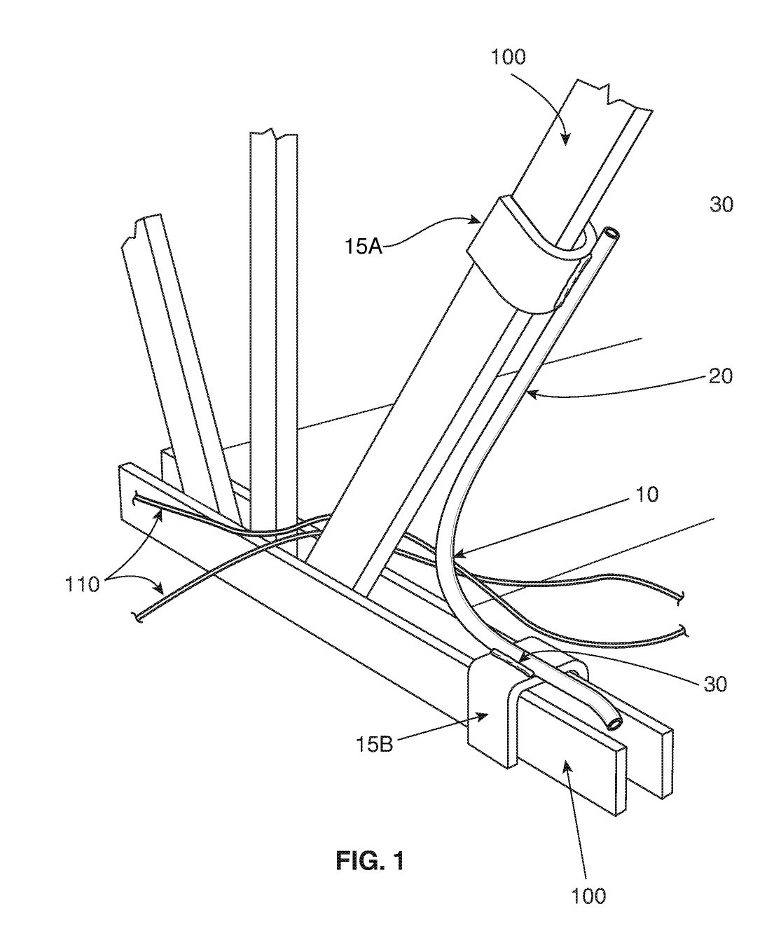

FIG. 1 is a perspective view of an example corner guide 10 for wire installation as it may be installed on the support structure 100 of a ceiling. It is noted, that the corner guide 10 may be utilized in any of a wide variety of applications and is not limited to use with any particular type and/or number of wire or cable. Nor is the corner guide 10 limited to any particular installation location. Although illustrated as the corner guide 10 may be installed in a ceiling 100 (e.g., around a truss or girder), the corner guide 1 may be installed in any structure.

In an example, the corner guide 1 includes fasteners or clips 15A and 15B. The fasteners or clips 15A and 15B may be secured to each end of a rod 20. In an example, the clips 15A and 15B are attached by smooth welds 30. However, the clips 15A and 15B may be provided on the rod 20 in any suitable manner, including but not limited to, being integrally formed as a single unit with the rod 20, include a cylindrical portion that is slid over the rod 20 etc.

In an example configuration, the corner guide 10 includes an eight inch rod, which may be preformed or bendable to a desired curvature or angle that fits the intended location. The corner guide 10 for wire installation also has two clips or “arms” clips 15A and 15B (e.g., steel weld clips) for attachment to the upper metal of a Prate Chord webbed truss 100 or other suitable location. The top and bottom clips clips 15A and 15B enable the rod 20 to hold fast to the truss webbing 100, e.g., while wires 110 are pulled around a corner.

The clips 15A and 15B are configured to maintain the corner guide 10 in position on a support structure 100 (e.g., a truss or girder in a ceiling or otherwise). The rod 20 and clips 15A and 15B are sufficiently strong and smooth to allow for pulling wires or cables 110 across the rod 20 and around a corner or bend, without causing abrasion of the insulation of the wires or cables 110. The corner guide 10 can also save time during wire installation, as there is no need to pull extra length of wires around corners to avoid damage to the wires 110.

In an example, the clips 15A and 15B of the corner guide 10 are made of a ductile or springy material such as metal, and may be bent around a truss or girder configuration of the structure 100 during installation. In another example, the clips 15A and 15B may be pre-formed at the time of manufacture to snap into place over a structure 100.

In an example, the rod 20 of the corner guide 10 is also made of a ductile or springy material such as metal and may either be bent to fit between two given girders or truss or other elements of the structure 100 at the time of installation. In another example, the rod 20 may be pre-formed at the time of manufacture to fit between two girders or trusses or other elements of the structure 100.

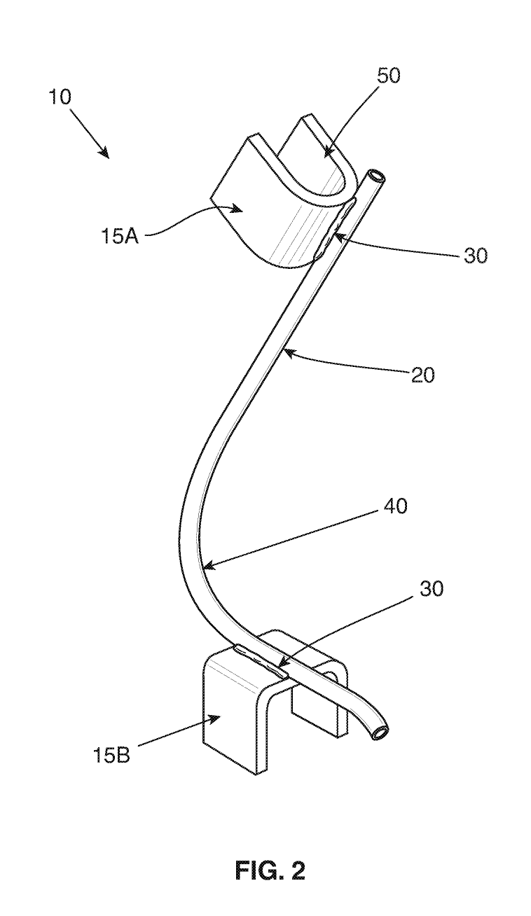

FIG. 2 is a perspective view of an example corner guide 10 for wire installation. An example corner guide 10 includes a rod 20. A first arm or clip 15A is provided at one end of the rod 20, and secured with a weld 30 or other attachment. A second arm or clip 15B is provided at an opposite end of the rod 20, and secured with a weld 30 or other attachment.

The rod 20 can be pre-formed or bent to a desired bend angle 40 so that the first and second arms 15A and 15B can be connected to a truss or other suitable location to provide a pass through for one or more wires or cables to be pulled around a corner (e.g., installed as shown in FIG. 1).

In an example, the arms or clips 10 of the corner guide 1 may be made from steel that is about 16 gauge in thickness, about 4 inches in width, and about 1.25 inches in height. As a design choice, other materials and dimensions may be employed to achieve the desired effect.

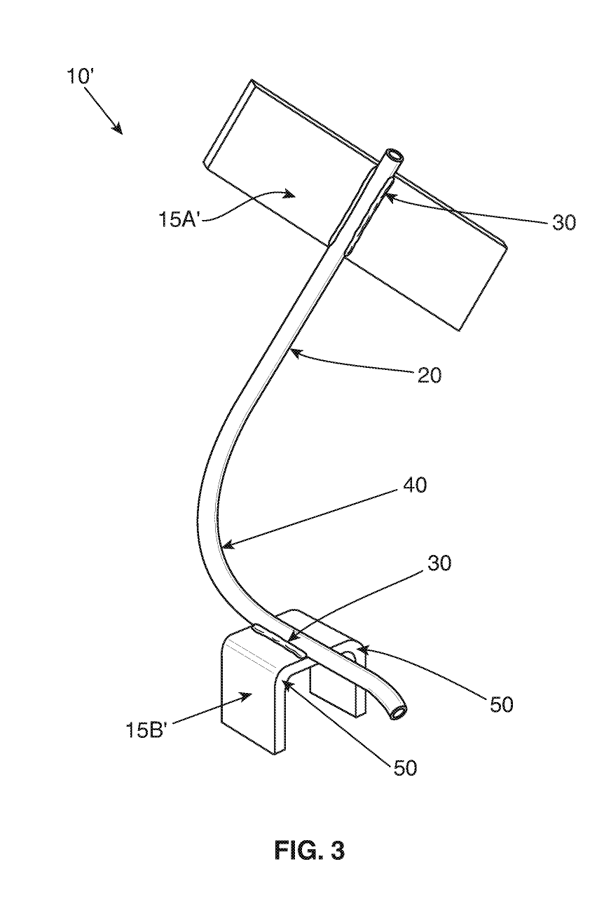

In an example, the arms or clips 15A and 15B each are configured with a curvature 50 that help secure it to the truss 100. In an example, the curvature 50 of a clip may have a U-bend or loop bend (e.g., as shown by clip 15A), with a curvature diameter of, for example, 2.5 inches, although other shapes may be employed to achieve the desired effect. In another example, the clip is substantially square-U-shaped. That is, the clip may include two 90-degree curves or bends 50 (e.g., as shown by the clip 15B in FIG. 3), such that the clip fits over a particular width of truss or girder of the structure 100. Other types of bends and curves 50 may also be employed to achieve the desired effect.

In an example, the surfaces of the clips 15A and 15B can be smoothed, coated, or finished to protect the wires or cables 110 being pulled through the corner. 11. In an example, at least one of the clips 15A and 15B are configured to form a tight fit with an element of a building structure to mount the rod to the element of the building structure, without any other attachment (e.g., without nails or adhesive). For example, the clips 15A and 15B may fit snugly or snap onto the element (e.g., a truss) such that the arms of the clips expand to bit over the element, and then press together or squeeze against the element to secure the clips in place on the element.

In an example, the rod 20 is made from ⅛″ rolled steel with a circular cross section, although as a design choice other diameters, materials, and cross sections may be employed to achieve the desired effect. In an example, the rod 20 is smoothed or coated to protect the wires or cables 110 being pulled through the corner. In an example, the rod 20 may be pre-bent to form a predetermined bend angle 40, or be bendable to any desired bend angle 40 during installation.

FIG. 3 is a perspective view of another example corner guide 10′ for wire installation. In this example, one of the clips 15A′ is substantially flat, and the other clip 15B′ is a square-U-shape. In this example, one of the clips 15A′ may be flat so that it can be attached in a flat configuration (e.g., screwed or nailed onto a rafter, truss, or girder of the structure 100). The clip 15A′ may also be bent during installation, e.g., to fit around mounting locations of various shapes and sizes.

In an example, the dips 15A′ and 15B′ of the corner guide 1 may be made from 16 gauge steel, and be about 4 inches wide and 1.25 inches tall. In an example, either or both of the clips 15A′ and 15B′ may be manufactured as flat, such that they can be bent or formed around a truss or girder of the structure 100 at the time of installation. In an example, either or both of the clips 15A′ and 15B′ may include two 90-degree clip bends 50, such that the clip 10 has a central region approximately 1.25 inches by 1.75 inches in size, and two bent gripping regions approximately 1.25 inches by 1.25 inches in size. As a design choice, other shapes, sizes, and bends 50 for the clips 15A′ and 15B′ may be employed to achieve the desired result.

It is noted that still other configurations are also contemplated, as will be readily understood by those having ordinary skill in the art after becoming familiar with the teachings herein. For example, one or both of the arms may be flat. Additionally, one or both of the arms may include any predefined shape (e.g., rectangular as shown in the drawings, semi-circular, triangular, etc.). The arms may include openings or holes for affixing the arm(s) with screws, nails or other fasteners.

The arms may include fasteners (e.g., spikes that can be hammered into wood) or friction elements (e.g., grooves or teeth) that prevent them from slipping when affixed to a rafter, girder, or truss 100.

Any of the elements described herein may be made from a variety of different materials, including but not limited to soft metals, hard metals, spring and memory alloys, plastics, polymers, meshes, woven and nonwoven composites, and wood.

Any of the elements described herein may include any of a variety of surface coatings or finishes intended to reduce any or all of friction, stiction, thermal conductivity, or electrical conductivity.

Instead of welds, the clips may be attached to the rod via brazing, soldering, sintering, adhesives, screws, nuts and bolts, or other related attachment mechanisms known in the art. As a design choice, the rod may be bent multiple times in different directions to conform to complex corner shapes. As a design choice, the clips may be bent or curved multiple times in different directions to conform to complex truss, girder, and rafter shapes.

The corner guide for wire installation may be used to route and protect electrical wires, signal wires, data cables, or antenna cables. The corner guide for wire installation may also be used to route and protect ropes, cords, chains, and other tethers, either to protect them from damage or to prevent them from damaging the corners around which they are routed.

It is noted that the examples shown and described are provided for purposes of illustration and are not intended to be limiting. Still other examples are also contemplated.

1. A corner guide for wire installation, comprising:
a rod bendable to a desired configuration;
a first clip at one end of the rod; and
a second clip at an opposite end of the rod;
wherein the first and second clips are connected to a building structure at or near a corner to secure the rod in position so that the rod provides a smooth surface for one or more of wires, cables, or bundles of wires to be pulled around the corner.

2. The corner guide for wire installation of claim 1, further comprising a coating or surface treatment on the rod to provide a smooth surface for pulling the wires, cables, or bundles of wires.

3. The device of claim 1, wherein the rod is pre-formed at a predetermined angle.

4. The device of claim 1, wherein the rod is bendable to a desired angle during installation.

5. The device of claim 1, wherein at least one of the first clip and the second clip is substantially flat for mounting to an element of a building structure.

6. The device of claim 1, wherein at least one of the first clip and the second clip is substantially U-shaped.

7. The device of claim 1, wherein at least one of the first clip and the second clip is substantially square-U-shaped.

8. The device of claim 1, wherein at least one of the first clip and the second clip is pre-formed for mounting to a predetermined element of a building structure.

9. The device of claim 1, wherein at least one of the first clip and the second clip is bendable to one or more desired shapes of an element of a building structure.

10. The device of claim 1, wherein at least one of the first clip and second clip are secured to the rod by weld.

11. The device of claim 1, wherein at least one of the first clip and the second clip is configured to form a tight fit with an element of a building structure to mount the rod to the element of the building structure without any other attachment.

12. A corner guide for wire installation, comprising:
a rod having a curvature;
a first clip at one end of the rod; and
a second clip at an opposite end of the rod;
wherein the first and second clips are connected to a building structure at or near a corner to secure the rod in position so that the rod provides a smooth surface for one or more of wires, cables, or bundles of wires to be pulled around the corner.

13. The device of claim 12, wherein the rod is pre-formed at a predetermined angle.

14. The device of claim 12, wherein the rod is bendable to a desired angle during installation.

15. The device of claim 12, wherein at least one of the first clip and the second clip is substantially flat for mounting to an element of a building structure.

16. The device of claim 12, wherein at least one of the first clip and the second clip is substantially U-shaped.

17. The device of claim 12, wherein at least one of the first clip and the second clip is substantially square-U-shaped.

18. The device of claim 12, wherein at least one of the first clip and the second clip is pre-formed for mounting to a predetermined element of a building structure.

19. The device of claim 12, wherein at least one of the first clip and the second clip is bendable to one or more desired shapes of an element of a building structure.

20. The device of claim 12, wherein at least one of the first clip and the second clip forms a tight fit with an element of a building structure to mount the rod to the element of the building structure without any other attachment.
